(19) United States
(12) Patent Application Publication
(10) Pub. No.: US 2006/0100783 A1
(43) Pub. Date: May 11, 2006

(54) Monitoring the surroundings of a vehicle

(75) Inventors: Manfred Haberer, Riegel (DE); Gerhard Dieterle, Simonswald (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sick AG, Waldkirch (DE)

(21) Appl. No.: 11/255,084

(22) Filed: Oct. 19, 2005

(30) Foreign Application Priority Data
Oct. 21, 2004 (DE) 102004051272.8

(51) Int. Cl. G08G 1/16

(52) U.S. Cl. 701/301; 340/436

(57) ABSTRACT

A method for monitoring the surroundings of vehicles, especially driverless transport vehicles, and controlling the vehicle. Objects in the surroundings of the vehicle are monitored with a surface sensor. Data generated by the surface sensor is grouped into monitoring strips that run parallel to the driving direction of the vehicle. A speed relative to the vehicle and parallel to the driving direction is determined for each monitoring strip. The positions of objects relative to the vehicle are determined, and objects are distinguished from each other on the basis of their relative speeds and/or positions. The possible occurrence of a collision of the vehicle with the object is calculated, and a signal is generated and sent to the vehicle for adjusting its speed and/or driving direction so that a collision with the object is prevented. The application also concerns apparatus for practicing the method.

### BACKGROUND OF THE INVENTION

The present invention concerns a method for controlling the surroundings of a vehicle with at least one touchless surface sensor mounted on the vehicle as well as an apparatus for controlling the surroundings of a vehicle with a touchless surface sensor mounted on the vehicle.

Such control systems for driverless transport systems are known. Driverless transport systems are employed for transporting a variety of materials, for example raw materials for articles being worked on in factories and the like. In such systems, the transport vehicles move along predetermined paths to working stations where the vehicles are stopped for loading and unloading.

Such driverless transport systems employ control sensors. Protected areas, and their dimensions, are determined on the basis of the direction of movement of the vehicle, its speed, and the needed distance for stopping the vehicle at given speeds to develop a control protocol. The protocol is then incorporated in an overall control system for a given direction and speed range. During the operation of such a vehicle, the control protocol is activated by the actual speed of the vehicle, and the protected area is monitored for obstacles, objects and the like that may have entered it. Such a control of the surroundings of an object is disclosed in German Patent Publication 102 38 759 A1. An optoelectronic sensor on the vehicle monitors the protected area and generates data relating to the objects in the protected area. The vehicle includes a processing unit for processing data generated by the sensor. The sensed data is then fed to a downstream control unit. The control unit reacts to the received data concerning the surroundings of the vehicle in accordance with a predetermined reactive strategy by generating a corresponding control signal. The processing unit includes at least two parallel, independent evaluation paths.

An effective monitoring of the surroundings of an object is quite costly. It requires reaction strategies which properly respond to the different situations the vehicle may encounter that must be programmed in for subsequent use. In addition, the monitored information about the surroundings of the vehicle must be weighted. A control signal for controlling the vehicle is then generated in dependency on the employed reaction strategy and the applied weighting of the information concerning the surroundings of the vehicle.

Prior art control sensors for driverless transport systems are pre-programmed for operating in a number of different protected areas of the surroundings and speeds of the vehicle. When operating at a given speed, the larger protected area must be selected for maximum speed. This ordinarily results in an overly large protected area for the speed of the vehicle. This in turn leads to unnecessary vehicle stops, which can be triggered by objects in the protected area which in fact do not constitute a danger. Recognized obstacles and resulting vehicle stops significantly reduce the productivity of such systems.

On prior art driverless transport systems, the control sensors are oriented in predetermined directions which define the protected areas. All obstacles encountered in such protected areas must be evaluated for braking the vehicle, or driving it around the obstacle, even if the obstacle might not be in the actual path of the vehicle.

The installation and startup of prior art control sensors for driverless transport systems are costly. For all situations that might be encountered, such as driving the vehicle through curves or approaching an obstacle, the protected areas must be configured according to the employed reaction strategies. Typically, the routes the vehicle will take in actual use are taught and learned by the vehicle by driving it over all possible routes, which is time-consuming.

Control sensors employed by prior art transport systems store only a limited number of protected area configurations. In use, prior art monitoring systems are switched so that the accessed control information is responsive to the encountered control circumstances.

### BRIEF SUMMARY OF THE INVENTION

It is an object of the present invention to provide an improved method and apparatus for controlling the surroundings of a vehicle, especially a driverless transport vehicle, so that the vehicle can be controlled and collisions are avoided. Objects located in the surroundings of the vehicle are recognized by a touchless surface sensor, and data generated by the surface sensor are then used for controlling vehicle movements.

This objective is attained by employing the method for controlling the surroundings of the vehicle, especially driverless transport vehicles, for steering the vehicle. Objects in the monitored surroundings are recognized by the touchless surface sensor which generates corresponding data. The generated data is grouped into monitoring strips that are oriented parallel to the driving direction of the vehicle. Further, the speed of an object relative to the vehicle in the direction parallel to the driving direction is determined for each monitoring strip, the position of the object relative to the vehicle is determined, objects are distinguished from each other on the basis of their speeds and/or their positions, possible collisions of the vehicle with objects are calculated, and a signal is generated and transmitted to the vehicle for adjusting its speed and/or its driving direction to prevent a collision.

The present invention has the important advantage that it provides a simple method and apparatus for monitoring the surroundings of the vehicle. It is relatively simple to divide data concerning the surroundings in the driving direction into monitoring strips or sectors. The distances and speeds of the object relative to the vehicle in the individual strips are readily used for initiating a braking maneuver or for driving around the object, because each of them involves only relatively minor computations.

Since the speed vectors for the different monitoring strips of the controlled surroundings can differ, stationary objects can be distinguished from moving objects. It is even possible to determine the relative speeds of two or more objects. Thus, objects which approach the vehicle, and objects that approach the vehicle at the highest speed, can be identified. By taking the braking characteristics of the vehicle into account, the initiation of a braking maneuver can thereby be delayed to the latest possible moment for stopping or avoiding the object.

The present invention has the advantage that the vehicle can be stopped as late as possible and/or the speed of the vehicle can be optimized, which enhances the efficiency of the material transport. It is further advantageous that the vehicle's own speed need not be determined. An emergency stop is thereby delayed to the latest possible point in time.

The present invention further permits an advantageous, early reduction in the speed of the vehicle to avoid emergency stops. This is especially helpful to avoid the need for rapidly stopping the vehicle from its full travel speed when it carries goods that might sustain damage when subjected to sudden emergency stops. In addition, the flow of goods and materials is more constant and more efficient when emergency stops are avoided.

Emergency stops can also be advantageously avoided by a timely change in the travel direction of the vehicle, particularly when there is room that allows the vehicle to maneuver around obstacles. This is also helpful for driving vehicles around other stationary vehicles that are being loaded or unloaded, for example.

In one embodiment of the present invention, the vehicle surroundings are monitored with a laser scanner that periodically scans the surroundings and determines the angle and distance to an object.

It is further desirable to orient the monitoring strips so that they coincide with the direction in which the vehicle moves. In this manner, objects, which are located outside the path traveled by the vehicle, do not interrupt the travel of the vehicle.

It is advantageous to calculate the maximum permissible speed of the vehicle for preventing a collision with objects in its path while maintaining a minimum distance from the object for the speed with which the vehicle travels. Such calculation will take into account the braking characteristics of the vehicle and the type of objects that are in its path. This yields an optimal speed for the vehicle and the material transport and therefore a cost reduction as compared to conventional transport systems.

It is preferred that the optimal maximum speed of the vehicle can be continuously adjusted. This subjects the vehicle to uniform and optimal movements and reduces the wear and tear on the vehicle components.

In one preferred embodiment, the maximum permissible speed for the vehicle is cyclically sent to a communication interface for control and steering of the vehicle. In this manner, the vehicle control can continuously accelerate or decelerate the vehicle for an optimal overall speed of the vehicle.

According to another, independent invention, an actual brake characteristic for the vehicle can be established on the basis of actual decelerations encountered during a braking maneuver. By determining the actual braking characteristic, decreases in the braking ability of the vehicle can be detected. With this information, objects are more easily avoided, for example by timely driving around the objects or with an earlier initiation of the braking action.

The present invention further changes the reach of the scanner into the protected space on the basis of the actual braking characteristics of the vehicle, typically by increasing the reach. As the vehicle's braking ability deteriorates, the reach of the periodic monitoring is increased as a function of the reduction in its braking ability. This permits an earlier detection of objects.

A further aspect of the present invention provides a display and/or generates a signal that the vehicle requires service or stopping in the event a limit value of the actual braking characteristic has been exceeded. Thus, a warning signal is generated and/or displayed, especially when the braking characteristic of the vehicle drops below a predetermined limit. The signal can be used to stop the vehicle for safety reasons when its braking characteristics deviate excessively from normal, for example by deactivating the drive of the vehicle. Alternatively, the drive of the vehicle and its speed can be reduced, for example for driving the vehicle to a maintenance location for service.

The objectives of the present invention are further attained with an apparatus for monitoring the surroundings of vehicles, especially driverless transport vehicles. Such apparatus has a touchless sensor for detecting objects in the surroundings of the vehicle as well as a processor to which the data received from the surface sensor is sent. The apparatus groups data in separate monitoring strips that are parallel to the driving direction of the vehicle and includes a device for each monitoring strip which determines the relative speed of the vehicle for each monitoring strip parallel to its driving direction, a device which determines the position of the object relative to the vehicle, appropriate sensors for distinguishing between objects on the basis of their relative speed and/or position, and a device which calculates when the vehicle might collide with an object and which generates signals that are sent to the vehicle for changing its speed and/or direction to prevent a collision.

In addition, for controlling the surroundings of the vehicle, the touchless surface sensor is preferably mounted on the vehicle at a predetermined position. This allows one to take the size and dimensions of the vehicle into account when an object is recognized and enables a precise determination if, and if so when, a collision with a stationary or movable object might occur.

It is further advantageous to construct the touchless surface sensor as an optoelectronic laser scanner. This type of optoelectronic sensor is particularly suited for monitoring the surroundings of a vehicle in accordance with the present invention.

It is preferred that parameters relating to braking characteristics of the vehicle be transmitted via at least one interface. This makes it possible, for example, to download parameters which can be used with or compared to actual measured parameters of the vehicle's braking characteristics. It is equally possible to upload parameters of the actual braking characteristics via the interface for further processing or use.

The method and apparatus of the present invention are also useful for use in fields other than vehicles, for example in connection with machine tools. When used on a press brake, it can be helpful to determine the stopping time for the moving tool. In such a case, the surface sensor controls the movement of the tool. If the deceleration of the press decreases, the change in the braking characteristics of the press is detected by the surface sensor, and a signal is generated for activating a warning system and/or for deactivating the machine. In such a case, it is not necessary to group the data to parallel monitoring strips because the tools are normally of a one-piece construction and move in only one direction.

The present invention is further described in connection with practical examples and by reference to the drawings.

### BRIEF DESCRIPTION OF THE DRAWINGS

FIG. 1 is a schematic representation of a vehicle supplied with a monitoring system according to the present invention for monitoring the surroundings of a vehicle;

FIG. 2 is a diagram which shows the position of the object at different points in time;

FIG. 3 is a diagram which shows the relative speed of the object at different locations;

FIG. 4 schematically shows the position of objects relative to an approaching vehicle;

FIGS. 5 and 6 are similar to FIGS. 2 and 3 and show the relative position and speed of the object at different times and different positions, respectively;

FIG. 7 shows the arrangement of FIG. 4 and the relative positions at a later point in time;

FIGS. 8 and 9 show the arrangement of FIGS. 2 and 3 but correspond to the situation shown in FIG. 7;

FIG. 10 shows the same arrangement as FIGS. 4 and 7 but illustrates the object and the vehicle at a still later point in time;

FIGS. 11 and 12 show the same arrangement as FIGS. 2 and 3 but correspond to the situation shown in FIG. 10; and

FIG. 13 schematically illustrates a vehicle which is in the process of turning and an object that is outside the protected area.

### DETAILED DESCRIPTION OF THE INVENTION

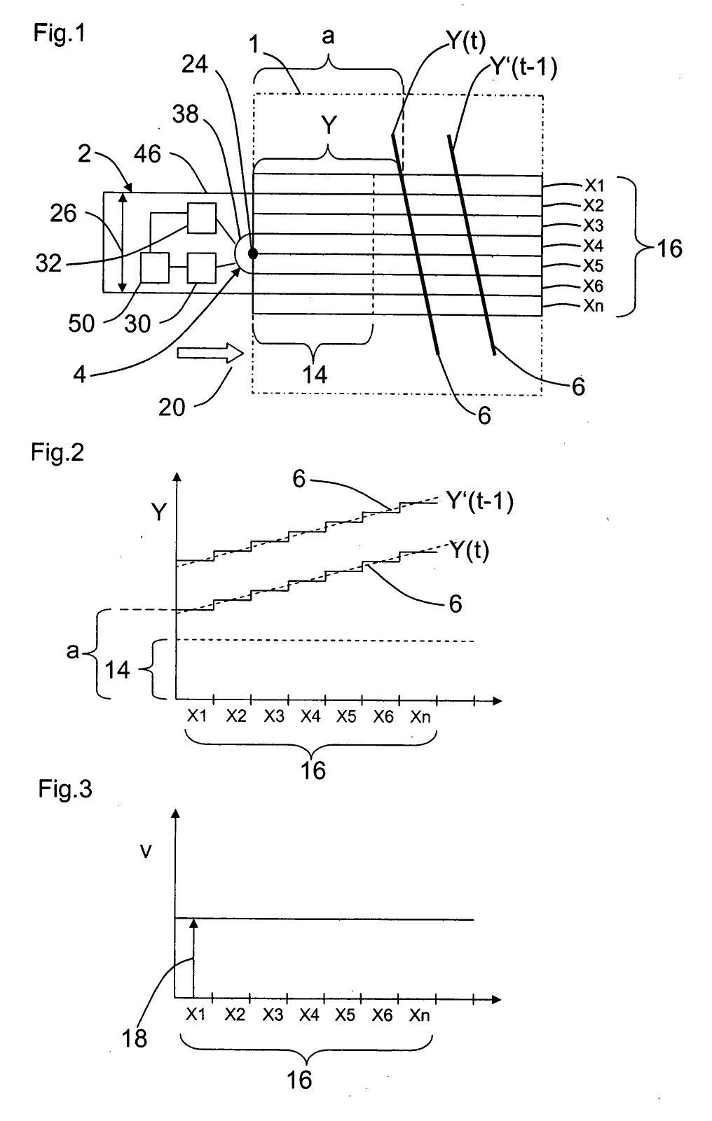

FIG. 1 shows a driverless transport vehicle 46. Driverless transport vehicles 46 are used by industry for transporting a variety of materials. The material transport takes place intermittently. To use as few driverless transport vehicles 46 for as many material transport trips as possible, the driverless transport systems must drive differing routes to different material loading and unloading stations. A given driverless transport system 46 must be able to drive along all these routes. Storing the different routes in each vehicle 2 is very costly. According to the present invention, only the desired destination needs to be inputted or supplied to the vehicle. Vehicle 2 is to find the desired destination itself while considering obstacles that may be present along its way. To properly orient itself within the surroundings, the vehicle must be familiar with the surroundings. For this, a touchless surface sensor 4 is mounted on vehicle 2. The surface sensor 4 monitors the surroundings and identifies the obstacles. A laser scanner 38 is preferably used as the surface scanner 4. Vehicle 2 has a vehicle control unit 32 which makes use of data generated by laser scanner 38 and with it determines how the vehicle should react. In particular, the vehicle control unit can initiate an early braking of the vehicle 2 when an object is recognized in the movement direction 20 of vehicle 2. Vehicle 2 has a steering system and a braking system 50. The vehicle control unit 32 is operatively coupled with the steering system and with braking system 50. In addition, there is a processing unit 30 which is directly coupled to the braking system. When an obstacle is recognized, processing unit 30 initiates a braking operation or an emergency stop.

Laser scanner 38 is an optoelectronic sensor which has a laser light, emitting unit and a receiving unit. The emitter directs a generated laser pulse via a rotating diverter mirror into the surroundings that are to be monitored. Reflected laser impulses are received by laser scanner 38 from the surroundings and are transmitted to the receiving unit via a partially transmitting mirror. The distances to the surroundings are determined by the processor on the basis of the time elapsed between emitting a laser pulse and the receipt of the reflected light pulse. The diverter mirror is rotated with a motor. Thus, laser scanner 38 monitors the surroundings in a fan-like manner with the emitted laser pulses. The data generated thereby are processed by vehicle control unit 32 and processing unit 30. Such a laser scanner 38 is for example described in published German Patent Application DE 43 40 756 C2.

Laser scanner 38 is mounted at about the front center of the vehicle at a position 24. The position of laser scanner 38 on vehicle 2 can be varied. Laser scanner 38 can also be mounted at the corner of a vehicle 2. Mounting the scanner at the center provides the scanner with like fields of views in the lateral directions of the vehicle. Vehicle 2 has a given width 26 which depends on the nature of the materials that need to be transported and the distance between adjacent vehicle paths. Vehicle 2 moves with a given speed within the vehicle paths. Laser scanner 38 of driverless transport vehicle 46 monitors the surroundings to prevent collisions between the vehicle, path borders or persons 44.

The angular and distance information sensed by laser scanner 38 are processed by processing unit 30 with the help of appropriate software programs. This involves the transformation of coordinates and grouping the monitored data into monitoring strips 16. This is schematically shown in FIG. 1. Monitoring strips 16 form a controlled area 1 and extend parallel to driving direction 20 since the danger of collisions exists only in that direction. With the data grouped in this manner, information concerning the controlled area is simple to use and requires only low-level, readily performed calculations. The width and number of monitoring strips 16 can be selected to yield the desired monitoring resolution. Objects entering the controlled area are monitored inside the individual strips 16. The distance Y of an object 6 in the controlled area is determined for each strip 16 into which the object extends. The relative speed “v” between vehicle 2 and object 6 in the driving direction is determined from several, successive, that is, timewise, spaced-apart scans. Processing unit 30 evaluates the data for the individual strips 16. Processing unit 30 can initiate an emergency stop of vehicle 2 by taking the vehicle's braking characteristics into consideration.

This is described in more detail with reference to FIGS. 1 to 2. Vehicle 2 moves with a speed in driving direction 20 towards an object 6. For example, object 6 can be inclined relative to vehicle 2. Object 6 is shown in a first position Y′ at time t-1 and at a later, second position Y at time t. After at least one scan, the distance Y for object 6 in each monitoring strip 16 can be determined. This is illustrated in FIG. 2. Additionally, with multiple scans of object 6 in each strip 16, a relative approach speed of the vehicle in driving direction 20 can be calculated. The result is illustrated in FIG. 3.

FIG. 2 shows the distance Y of object 6 as it is positioned in multiple strips 16. The abscissa shows the individual strip 16 (X1-Xn). The corresponding distance Y is shown on the ordinate. The drawings each show the distances Y′ and Y at times t-1 and t, respectively. The distances Y of object 6 are shown as a stepped function in the diagram. Only one distance Y for object 6 is determined and shown for each monitoring strip which results in the stepped function mentioned above. To better illustrate this, the actual distances Y of all parts of the object 6 are also shown by a dotted line without a step for each monitoring step. The distance of object 6 increases for each monitoring strip 16. The drawings illustrate that for the detected object 6, only seven discrete distances were taken into consideration for estimating the distance of the object. This allows one to quickly determine the contour surrounding vehicle 2. The width of monitoring strips 16 depends on the desired resolution. The narrower the strips 16 are, the higher is the resolution of the scanned surroundings.

FIG. 3 shows the relative speed between object 6 and vehicle 2 in FIG. 1 at the different monitoring strips 16. The abscissa shows the individual monitoring strips 16 (X1-Xn). The ordinate shows the relative speed “v” at each monitoring strip 16. Relative speeds between vehicle 2 and object 6 are provided for each monitoring strip. Here the relative speed is the same for all strips 16. Object 6 and vehicle 2 therefore move linearly towards each other. As an example, the speed vector 18 at the first monitoring strip only is shown in FIG. 3.

The minimum distance “a” of object 6 is shown in FIG. 1. A minimum distance 14 between object 6 and vehicle 2 that should be maintained is calculated in dependency on the braking characteristics and the speed of the vehicle. This permissible minimum spacing 14 is also dependent on the relative speed of object 6 and vehicle 2. The greater this speed is, the larger the needed minimum distance 14 must be. The greater the possible delay in activating braking system 50 is, the greater the needed minimum distance 14 should be. When the detected object enters this defined minimum distance 14, a braking action is initiated, or the control unit causes the vehicle to drive around the object. The minimum distance 14 to object 6 or to persons is shown as a dotted line.

The greatest possible speed of vehicle 2 without leading to a collision is calculated on the basis of the smallest permissible distance of the object 6 and the relative speed 18 between vehicle 2 and the object. The calculation will take into consideration the braking characteristics of the vehicle. This greatest permissible speed can be relayed to the vehicle control unit 32 via a communication interface. This way the vehicle 2 can operate at the maximum permissible speed. In this manner, the efficiency of the transport system with a driverless transport vehicle 6 can be enhanced.

It is also possible to determine increasing delays in the operation of the brake system 50. For example, when an object is recognized that requires an emergency stop, the decreasing distance Y during the braking maneuver can be determined and made use of. The current braking characteristics of braking system 50 are determined by the processing unit 30 on a real-time basis and used by vehicle control 32 to establish new braking characteristics which are then used to change the manner in which the vehicle is driven, and its speeds. A decreasing effectiveness of the braking system leads to a reduction in the greatest permissible speed of vehicle 2.

As the effectiveness of braking system 50 decreases, the reach of the periodic sensing into the surroundings is changed, typically it is increased. By increasing the reach, more distant objects can be recognized and taken into consideration earlier. A decreasing effectiveness of the braking system 15 can thereby be compensated for by initiating the braking of the vehicle, or an emergency stop thereof, at an earlier point in time.

An observed change in the actual braking characteristics can also be shown, for example on a display, or a corresponding signal can be generated for further use and processing. This alerts a person responsible for the braking system 15, who then can take necessary steps such as inspecting it. When a limit value that has been set for braking characteristics is exceeded, the vehicle can be stopped out of safety consideration, or it can continue to operate but under a reduced speed.

Processing unit 30 has at least one interface for the transmittal of parameters for the braking characteristics. The parameters of the braking system 50 are sent to processing unit 30 via this interface so that they can be taken into consideration while the vehicle is in motion. Further, parameters concerning the actual, measured braking characteristics can also be transmitted via this interface. These parameters can be used, for example, by vehicle control unit 32 for further processing.

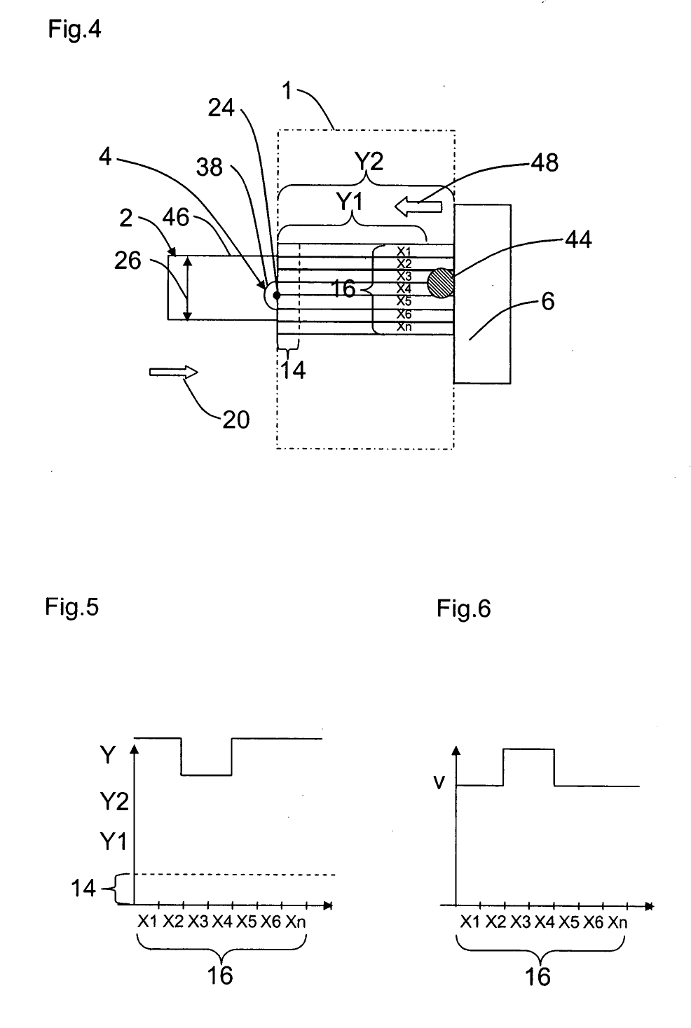

FIGS. 4, 7 and 10 illustrate the present invention as it unfolds at different points in time. FIGS. 4, 7 and 10 generally correspond to FIG. 1. In this series of figures, a person 44 approaches vehicle 2 in a direction 48 that is opposite to the driving direction of vehicle 2. Vehicle 2 approaches object 6 and person 44. Object 6, which could be a wall, does not move.

The diagrams shown in FIGS. 5, 8 and 11 each illustrate what is happening in FIGS. 4, 7 and 10. They show the distances Y1 or Y2 between vehicle 2 and person 44 or wall 6 in the same manner in which this is shown in FIG. 2. The diagrams of FIGS. 6, 9 and 12 illustrate what is happening in FIGS. 4, 7 and 10 in regard to the relative speeds between vehicle 2 and object 6 or person 44 in the same manner in which this is shown in FIG. 3.

FIG. 4 shows vehicle 2 as it approaches wall 6 at a given speed in drive direction 20. A person 44 additionally approaches the vehicle in the direction 48 that is opposite to driving direction 20. The distances Y1 and Y2 of person 44 and wall 6, respectively, are determined for the individual monitoring strips 16. On the basis of previous scans of the surroundings, the relative speed of wall 6 and person 44 is determined for the individual monitoring strips 16, while taking the minimum distance 14 into account.

FIG. 5 shows the different distances Y1 and Y2 of person 44 and wall 6 shown in FIG. 4. The distances Y1 of person 4 are shown for monitoring strips X3 and X4. Distances Y2 between person 44 and vehicle 2 are less than the distances Y2 of wall 6 in the remaining monitoring strips 16 because the person is positioned in front of the wall.

FIG. 6 shows the different speeds between person 44 and wall 6 relative to vehicle 2 illustrated in FIG. 4. The relative speed between person 44 and vehicle 2 is shown for monitoring strips X3 and X4. The relative speed between person 44 and vehicle 2 is greater than the relative speed in the remaining strips 16 between the vehicle 2 and wall 6.

The processing unit can distinguish wall 6 from person 4 because of the different monitored speeds and/or positions of the wall and the person. Person 44 and other objects 6 can move in different directions. For example, the person can move towards the vehicle, or it can move transversely to the driving direction of the vehicle. Person 44 can also move away from vehicle 2. The vehicle movement is corrected on the basis of how person 44 or the objects move. Process unit 30 can initiate a braking maneuver, or drive the vehicle around the obstacle, dependent on the detected motions, especially for persons which may be closer to and/or approach the vehicle at a greater speed. Since the person 44 illustrated in FIG. 4 is still relatively far away from the distance limit 14 to vehicle 2, the vehicle 2 continues to move in the original direction 20 towards person 44.

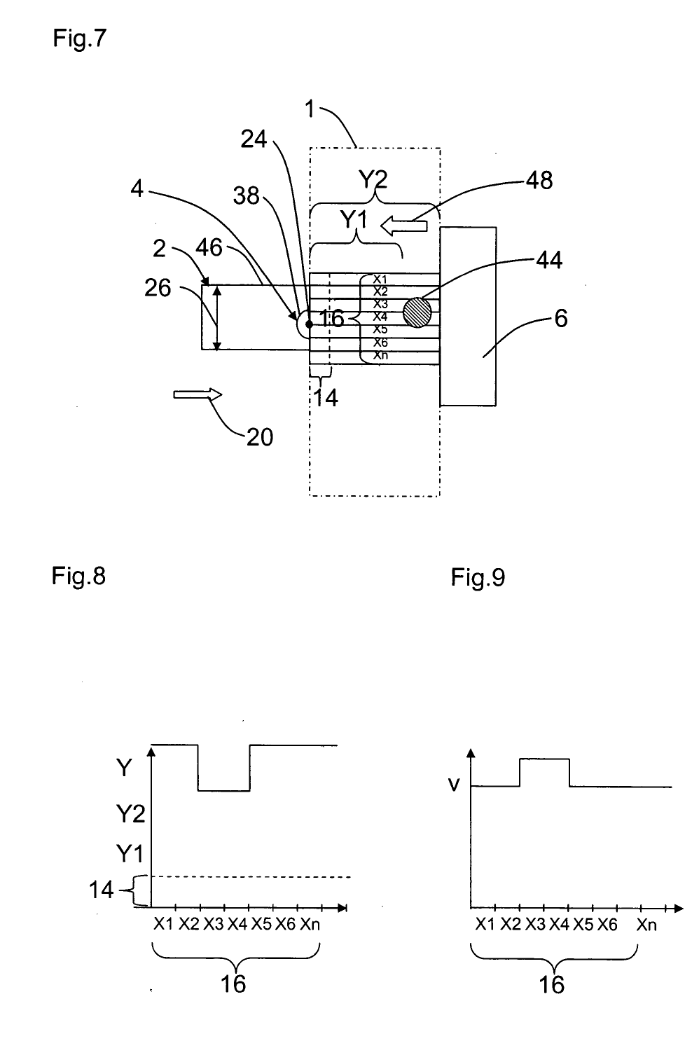

FIG. 7 is similar to FIG. 4 but shows the situation at a later point in time when vehicle 2 has approached and is relatively closer to person 44 and wall 6. The person 44 has reduced the speed of its approach towards the vehicle.

FIG. 8 illustrates the relatively smaller distance of person 44 and wall 6 to the vehicle as compared to what is shown in FIG. 5. Person 44 has come even closer to the permissible minimum distance 14. Monitoring strips X3 and X4 also show that the person 44 is now further away from wall 6. In view of the small distance that now exists between person 44 and vehicle 2, the speed of the vehicle can be reduced.

FIG. 9 shows relative speeds. The relative speed between wall 6 and vehicle 2 remains unchanged. The relative speed between person 44 and vehicle 2, shown in strips X3 and X4, is reduced relative to the speed as shown in FIG. 6.

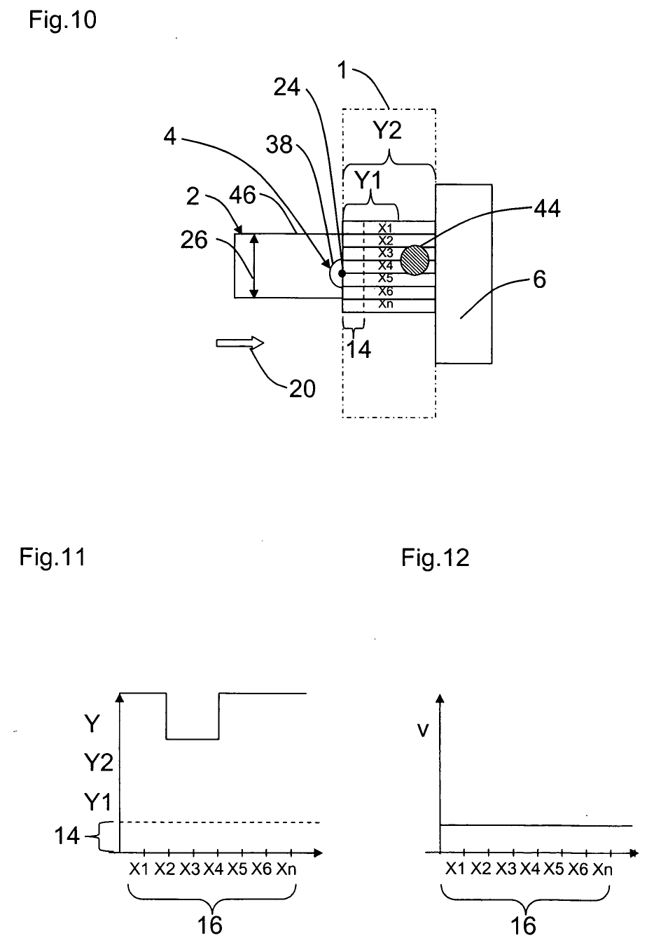

FIG. 10 shows the positions of the object and the person at a still later point in time. The vehicle has further reduced its speed. Person 44 additionally moved closer to vehicle 2. FIG. 11 shows the reduced distance between vehicle 2 and person 44. The distance to the permissible minimum spacing 14 has been further reduced. In comparison to FIG. 8, the distance between person 44 and wall 6 remained constant. FIG. 12 shows the changed speeds relative to what is shown in FIG. 9. The relative speeds shown in all monitoring strips 16 remains the same because person 44 no longer moves towards vehicle 2. Since the vehicle has reduced its speed, the shown speed is less as compared to the speeds shown in FIG. 9.

The processing unit would have to initiate an emergency stop in the event person 44 enters the minimum distance 14 to vehicle 2. Beginning with the situation illustrated in FIG. 10, vehicle 2 could also change its travel direction and drive around person 44.

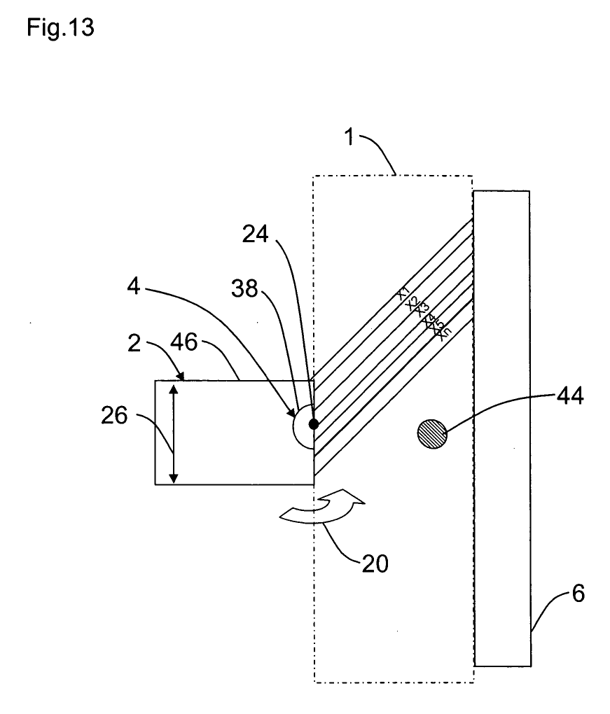

FIG. 13 shows that vehicle 2 has changed its direction of movement. FIG. 13 generally corresponds to FIG. 1. Vehicle 2 turns to the left in direction 20. In such a case, the data supplied to the monitoring strips is adjusted for the new driving direction 20. Thus, person 44 is no longer in danger of being hit by vehicle 2; likewise, the movement of vehicle 2 is no longer endangered.

1. A method for monitoring a surroundings of a vehicle for use in controlling motions of the vehicle comprising sensing the objects in the surroundings with a touchless surface sensor which generates data, grouping the sensed data in monitoring strips which extend parallel to a driving direction of the vehicle, determining a relative speed of the vehicle in a direction parallel to its driving direction for each monitoring strip, with the data generated by the surface sensor determining a position of the object relative to the vehicle, distinguishing between a plurality of objects in the surroundings as a function of at least one of the speed of the vehicle and the position of the object, calculating when a collision between the vehicle and the object can occur, and generating and transmitting a signal to the vehicle for adjusting at least one of its speed and its driving direction to prevent the collision.

2. A method according to claim 1 wherein the surroundings is monitored with a laser scanner, and including periodically sensing an angle and a distance of the object to the vehicle.

3. A method according to claim 1 including changing an orientation of the monitoring strips to correspond to changes in the driving direction of the vehicle.

4. A method according to claim 1 including determining a minimum required distance between the vehicle and one of the objects for preventing a collision, and calculating a maximum permissible speed the vehicle can have without entering the minimum distance by taking into account braking characteristics of the vehicle and the sensed objects relative to the vehicle.

5. A method according to claim 1 including cyclically communicating the maximum permissible speed to a processing unit via a communications interface.

6. A method according to claim 1 including determining an actual braking characteristic for the vehicle on the basis of a braking maneuver from an actually encountered deceleration of the vehicle.

7. A method according to claim 1 including changing, especially increasing, periodic sensing on the basis of an actual braking characteristic.

8. A method according to claim 1 including at least one of generating a signal and displaying a message for servicing or stopping the vehicle when the actual braking characteristic has exceeded a predetermined limit.

9. Apparatus for monitoring the surroundings of a vehicle comprising a touchless surface sensor for detecting objects located within the surroundings which generates data concerning the relative location of the objects, a processor which groups the data from the surface sensor into monitoring strips that extend parallel to the driving direction of the vehicle, a device which determines a speed parallel to the driving direction and relative to the vehicle, a discriminator that distinguishes the objects on the basis of at least one of their relative speeds and positions, a processor adapted to calculate a possible collision between the vehicle and the objects, and a transmitter relaying to the vehicle a signal for adjusting at least one of the vehicle's speed and driving direction for preventing the collision.

10. Apparatus according to claim 9 wherein the touchless surface sensor comprises a laser scanner.

11. Apparatus according to 9 wherein the touchless surface sensor for monitoring the surroundings is mounted at a predefined position on the vehicle.

12. Apparatus according to claim 9 comprising a controller for determining the time required for decelerating the speed of the vehicle as a result of a braking maneuver executed by the vehicle, a processor for determining the deceleration of the vehicle during the braking maneuver, and a memory for storing parameters concerning actual braking characteristics.

13. Apparatus according to claim 9 including an adjuster for varying a reach over which the surface sensor is operative.

14. Apparatus according to claim 9 including at least one of a display and a signal output for providing information concerning servicing the vehicle or preventing further use of the vehicle when an actual braking characteristic of the vehicle exceeds a predetermined, characteristic limit value thereof.

15. Apparatus according to claim 9 including at least one interface for transmitting parameters relating to a braking characteristic of the vehicle.
